(19) United States
(12) Patent Application Publication
(10) Pub. No.: US 2016/0275116 A1
(43) Pub. Date: Sep. 22, 2016

(54) FREEWARE AND OPEN SOURCE SOFTWARE DATA MANAGEMENT AND ANALYTICS SYSTEM

(71) Applicants: Yan SHI, Richmond (CA); Navjot SINGH, Vancouver (CA); Zifei SHI, Vancouver (CA); Hamad ZAWAWI, Vancouver (CA); Baljeet Singh MALHOTRA, Vancouver (CA)

(72) Inventors: Yan SHI, Richmond (CA); Navjot SINGH, Vancouver (CA); Zifei SHI, Vancouver (CA); Hamad ZAWAWI, Vancouver (CA); Baljeet Singh MALHOTRA, Vancouver (CA)

(21) Appl. No.: 14/662,571

(22) Filed: Mar. 19, 2015

(51) Int. Cl. G06F 17/30

(52) U.S. Cl. CPC G06F 17/30315; G06F 17/30528; G06F 17/30958

(57) ABSTRACT

A computer-implemented method for analyzing free and open source software (FOSS) data related to FOSS components in source or binary codebase include receiving, by a computer, FOSS data. Each data record in the FOSS data includes identification of a FOSS component in source or binary codebase and data on one or more attributes of the FOSS component. The computer-implemented method further includes storing the FOSS data in a column-based database and querying the FOSS data stored in the database to extract information to put in a FOSS compliance, quality or security report or bill of materials (BoM) for the source or binary codebase.

### BACKGROUND

Organizations world wide rely more and more on networked computer systems for information and services. An organization's computer system may have software codebase of hundreds or thousands of different computer applications or software (“software applications”). The software codebase may include source and/or binary codebases. The software applications may include some applications that have been internally developed and other applications that are vendor-developed. In either case, the applications may include numerous common components (“third-party components”) that are developed by or sourced from third parties.

The third-party components may be “Free Open Source Software (FOSS)” components. While FOSS may be available free of cost from the open source community of developers, there are concomitant license obligations that the organization using FOSS must fulfill. FOSS compliance or governance may refer to the aggregate of policies, processes, training, and tools that enables an organization to effectively use FOSS components and contribute to the open source communities while respecting copyrights, complying with license obligations, and protecting the organization's intellectual property and that of its customers and suppliers.

An aspect of FOSS compliance or governance involves automated scanning the software codebase (“FOSS scans”) using open source scanning tools to detect the presence of FOSS in the organization's computer systems. Software components may be detected and identified as being FOSS components by matching with known open source components (which may be stored in “Knowledge Base (KB)”). The open source scanning tools can generate data (“FOSS data”) including, for example, source and/or binary codes of FOSS, identification of the FOSS components, directory locations of the FOSS components, the potential origins of FOSS components, legal notices (licenses) and other information related to sundry technological legal or policy obligations attached to use of the detected FOSS components. The open source scanning tools may include tools that are (e.g., OSS Discovery) available for free from non-profit organizations (e.g., Linux Foundation) or tools that are available from commercial vendors (e.g., Antelink, Black Duck Software, nexB, OpenLogic, Palamida, Protecode, etc.). Experts (e.g., technology legal experts, compliance analysts, license specialists, etc.) may prepare compliance, quality or security reports, which may include plans of action for compliance (e.g., license/quality/security compliance), by querying, analyzing and evaluating the FOSS data generated by the automated scans. The compliance, quality or security reports may be collectively referred to herein as “compliance reports.”

Unfortunately, the volume of FOSS data generated by the FOSS scans can be large and require correspondingly large storage. Further, query processing and analytics of the large volume of FOSS data required to prepare compliance reports can be time consuming. For instance, a scan of a typical software project of an organization may generate tens or even hundreds of gigabytes of data containing various pieces of FOSS-related information. Experts may need several days to query, analyze or evaluate the large volumes of FOSS data in order to prepare compliance reports. Thus, even though open source scanning tools are used for automated detection of FOSS in the organization's computer systems, timely FOSS compliance by the organization can be difficult and time consuming because the volume of FOSS data generated can be overwhelming large.

Consideration is being given to systems and methods for conducting FOSS scans of an organization's computer systems. Attention is directed to systems and methods for generating and managing useful amounts of FOSS data for FOSS compliance, while keeping in view both the requirements for data storage and the need for speedy analysis of the FOSS data.

### SUMMARY

Computer-implemented methods and systems for analyzing free and open source software (FOSS) data related to FOSS systems and components in source or binary codebase and/or text data written in natural languages is disclosed herein. The methods and systems involve, receiving, by a computer, the FOSS data. Each data record in the FOSS data includes identification of a FOSS component in the source or binary codebase and data on one or more attributes of the FOSS component. The methods and systems further involve storing the FOSS data in a column-based relationship database; and querying the FOSS data stored in the database to extract information to put in a FOSS compliance, quality or security report or bill of materials (BoM) for the source or binary codebase.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIG. 1 is a schematic block diagram of an example system for collecting, managing and analyzing FOSS data, in accordance with the principles of the present disclosure.

FIG. 2 is a schematic illustration of an example database table, a row-based representation of the database table, and a column-based representation of the database table.

FIG. 3 is a schematic block diagram illustration of a database management system for collecting, managing and analyzing FOSS data that is stored as a graph structure in a graph database, in accordance with the principles of the present disclosure.

FIG. 4 is a schematic illustration of an example hierarchical tree structure model of FOSS data for the source code of a scanned software project, in accordance with the principles of the disclosure herein.

FIG. 5 is a schematic illustration of example vertex or node properties and example edge properties characterizing a tree structure model of FOSS data, in accordance with the principles of the disclosure herein.

FIG. 6 illustrates a table representing vertices and vertex attributes of a graph structure of FOSS data, in accordance with the principles of the disclosure herein.

FIG. 7 illustrates a table representing edges and edge attributes of a graph structure of FOSS data, in accordance with the principles of the disclosure herein.

FIG. 8 is a table illustrating results of an experiment to evaluate query execution times on the three different computing platforms, in accordance with the principles of the disclosure herein.

FIG. 9 illustrates an example method for collecting, managing and analyzing information (“FOSS data”) on free open source software (“FOSS”) components in computer systems or products of an organization, in accordance with the principles of the disclosure herein.

### DETAILED DESCRIPTION

Computer-implemented systems and methods (collectively “solutions”) for collecting, managing and analyzing information (“FOSS data”) on free open source software (“FOSS”) components in computer systems or products of an organization are described herein.

The FOSS data records may, for example, include identification of the FOSS components, directory locations (e.g., folder, files, sub-folders, etc.) of the FOSS components, information on potential origins of the FOSS components, legal notices (licenses), and other information related to various technological legal and policy obligations of using the FOSS components. The FOSS data may be used to prepare FOSS compliance reports, which may include action plans directed toward ensuring compliance with the legal obligations and/or policies of the organization related to the use of the FOSS components in the organization's computer systems or products. The compliance reports may be referred to herein as the “Bill of Materials” or “BoM.”

The solutions described herein may involve using available open source scanning tools to scan the software codebase in the computer systems to generate the FOSS data. The open source scanning tools may include, for example, tools that are (e.g., OSS Discovery) available for free from non-profit organizations (e.g., Linux Foundation) or tools that are available from commercial vendors (e.g., Antelink, Black Duck Software, nexB, OpenLogic, Palamida, Protecode, etc.).

The FOSS data generated by an open source scanning tool may include software scan results, which may identify or describe the provenance of various FOSS components in the software codebase by matching detected FOSS components with known open source software components (which may be stored, for example, in a knowledge base (KB)). For the software codebase of a large computer system or software project of the organization, the software scan results may, for example, number in the millions and may include millions or billions of lines of code. Open source scanning tools, which use row-based storage of the software scan results, can require correspondingly large storage to store the millions or billions of lines of code in the software scan results/FOSS data.

A high degree of redundancy may be inherent in the software scan results of a software codebase. Each FOSS component in the scanned software codebase may, for example, be matched to one or more known open source software components. Further, many of the detected FOSS components in the scanned software codebase may, for example, be duplicative or repetitive or may have the same source of origin or provenance. Thus, the software scan results, which identify or describe the provenance of various FOSS components, may include similar, duplicative, or redundant pieces of information.

In one aspect, recognizing the degree of redundancy inherent in the software scan results, the solutions for collecting, managing and analyzing FOSS data described herein may involve data compression of the FOSS data. In particular, the solutions may utilize column-based storage of the software scan results to achieve data compression, in accordance with the principles of the disclosure herein. This data compression may reduce the size of the software scan results/FOSS data that needs to be stored. The column-based storage described herein may exploit the data redundancy in the software scan results to achieve significant data compression of the software scan results/FOSS data. In example scenarios, data compression factors of ˜10-20× may be expected for column-based storage compared to row-based storage of the software scan results/FOSS data.

In another aspect, the solutions for collecting, managing and analyzing FOSS data described herein may use graph-based data modeling techniques to model and store the FOSS data as graph structures for query processing and analytics, in accordance with the principles of the disclosure herein. The FOSS data may be stored in a graph database as the modeled graph structures characterized by vertices or nodes, edges, and properties. The modeled graph structures may stored in representations that are amenable or suitable for semantic queries.

A column-oriented, relational database management system (RDBMS) (e.g., SAP HANA, which is an in-memory, column-oriented, relational database management system developed and marketed by assignee SAP SE) may be used as a platform to implement the solutions for collecting, managing and analyzing FOSS data. In example implementations, the relational database management system may be utilized to store the FOSS data, for example, in a column-based database or a graph database. Further, a query processing engine may be configured for real-time query processing of the FOSS data stored in the column-based or graph databases.

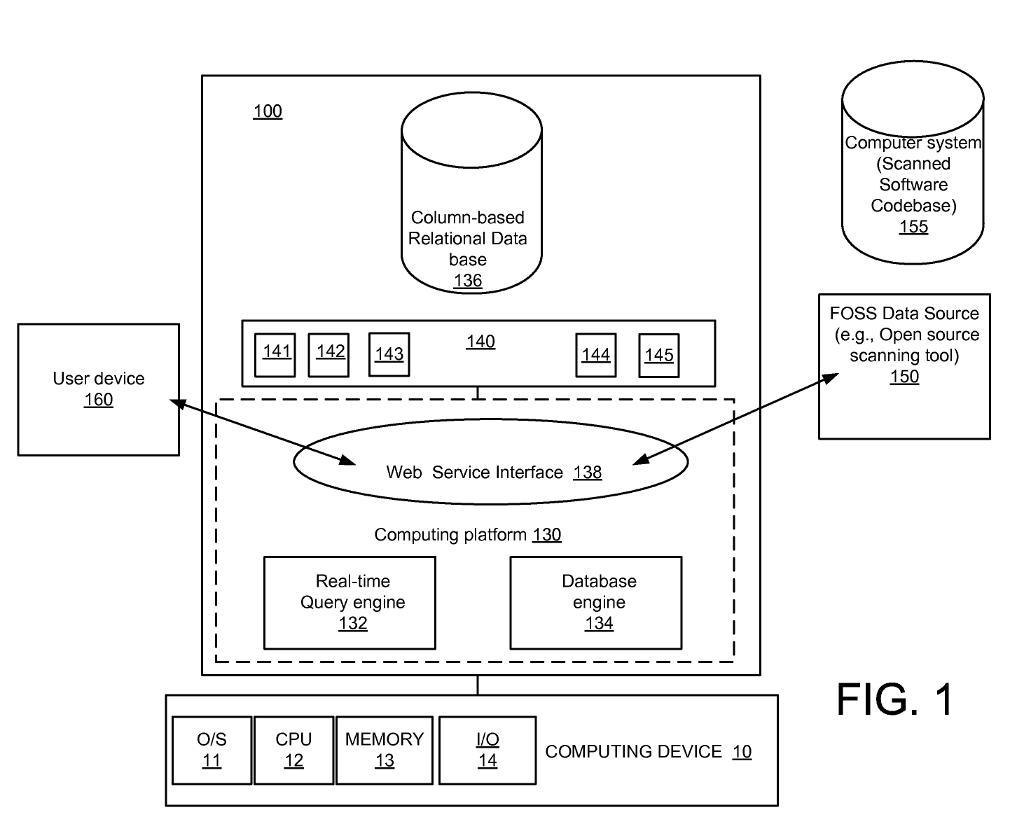

FIG. 1 shows an example relational database management system (RDBMS) 100, which may include an example application (e.g., “FOSS Data Management and Analysis” application 140) for collecting, managing and analyzing FOSS data, in accordance with the principles of the present disclosure. The FOSS data, which may be generated by an open source software scanning tool, may be related to FOSS components in a source codebase or computer systems or products of an organization. FIG. 1 shows, for example, RDBMS 100 coupled to a FOSS data source 150 (e.g., an open source scanning tool). FOSS data source 150 may generate FOSS data, for example, by scanning a computer system/software codebase 155 to detect and identify FOSS components and related information in computer system/software codebase 155. FOSS data source 150 may provide the generated FOSS data to RDBMS 100 for processing, for example, by application 140. In an example implementation, application 140 may include one or more modules 141-145 (e.g., code scans 141, code analysis 142, BoM management 143, license management 144, and data and visual analytics 145) that are configured to provide one or more functions (e.g., code scans, code analysis, BoM management, license management, and data and visual analytics) that may be used for FOSS compliance, quality, and security processes (which may be collectively referred to herein as “FOSS compliance” processes).

RDBMS 100 may be hosted on or distributed over one or more physical machines in a computer network. For visual clarity, FIG. 1 shows RDBMS 100 hosted, for example, on a computer 10, which includes an O/S 11b, a CPU 12b, a memory 13b, and I/O 14b. Although computer 10 is illustrated in the example of FIG. 1 as a single computer, it may be understood that computer 10 may represent two or more computers in communication with one another in a computer network. Therefore, it will also be appreciated that any two or more components of system 100 may similarly be executed using some or all of the two or more computers in communication with one another. Conversely, it also may be appreciated that various components illustrated as being external to computer 10 may actually be implemented therewith.

RDBMS 100 may include a computing platform 130 on which application 140 may be launched. Computing platform 130 may include or be coupled to one or more platform components (e.g., a query processing engine 132, a database engine 134, a relational database 136, and a services interface 138), which may support or enable the various functions of application 140. Query processing engine 132 may be configured for real-time query processing of the FOSS data stored, for example, in the column-based or graph databases. In an example implementation based on a HANA platform, the query engine may be configured to process queries written, for example, in WIPE graph language.

With reference to the components of RDBMS 100, services interface 138 may, for example, be a web-services interface, which provides communication links to external devices (e.g., user device 160, FOSS data source 150, etc.) via the Internet. User device 160 may be a computing device (e.g., a laptop computer, a desktop computer, a mobile computing device, etc.) via which a user can interact with RDBMS 100 and operate, for example, one or more functions of application 140 launched on computing platform 130. In an example implementation, application 140 may include one or more modules 141-145 (e.g., code scans 141, code analysis 142, BoM management 143, license management 144, and data and visual analytics 145) that are configured to provide one or more functions (e.g., code scans, code analysis, BoM management, license management, and data and visual analytics) that may be used for FOSS compliance, quality or security processes.

Column-based relational database 136 may, for example, be an in-memory database. Database engine 134 may be configured to process and compress FOSS data (e.g. received from FOSS data source 150) for storage, for example, attribute-by-attribute or column-by-column in relational database 136.

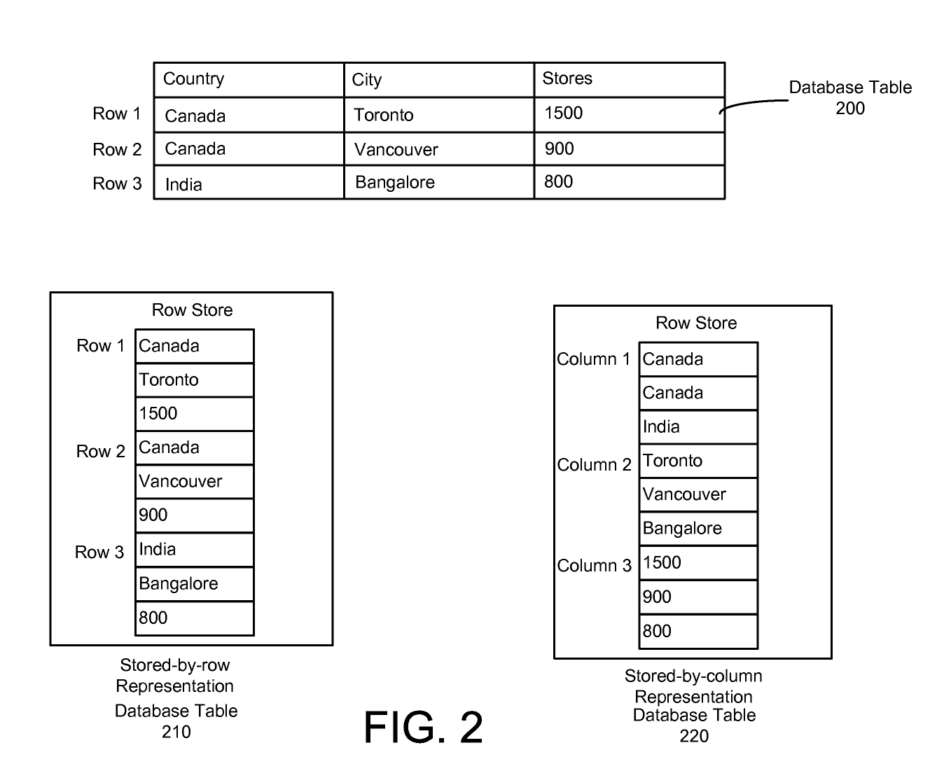

In column-based relational database 136, contiguous memory locations may be used to store data values for same attributes belonging to different data records. Contiguous memory locations may, for example, store values in fields belonging to different rows of a database table under a same data attribute or column heading. FIG. 2 illustrates visually how data values of an example database table 200 (e.g., a table with three data records: row 1, row 2 and row 3) may, for example, be stored row-by-row in a conventional row-based representation 210 and attribute-by-attribute or column-by-column in a column-based representation 220 (e.g., in column-based relational database 136).

It will be noted that column-by-column data storage enables substantial data compression if a data table has large number of repetitive values for the data attributes (column headings). For a test demonstration, example open-source code scan results/FOSS data stored row-by-row in a relational table contained approximately 109 million data rows and required approximately 44 Gb of memory for storage. However, storing the same data column-by-column in a column-based relational database required only approximately 2.2 Gb of memory. These test demonstration results showed that column-by-column storage of the example open-source code scan results/FOSS data yielded a data compression of about 94%.

Column-based storage of the FOSS data in relational database 136 may enable fast data access and retrieval of data as only the column specified in a search query may have to be read from storage. Further, it will be noted that in column-based storage, the FOSS data is partitioned vertically. This partitioning may allow operations on different columns of the stored FOSS data to be processed in parallel. For example, if a search query specifies multiple columns, each of the specified columns may be processed in parallel by a separate processor core (not shown) in RDBMS 100.

As noted previously in an alternative example implementation of the solutions for collecting, managing and analyzing FOSS data described herein, the FOSS data may modeled as a graph structure and stored as such in a graph database for query processing and analytics, in accordance with the principles of the disclosure herein. The FOSS data may be stored in the graph database as a graph structure with nodes, edges, and properties to represent the data. The graph structure may be amenable or suitable for semantic queries.

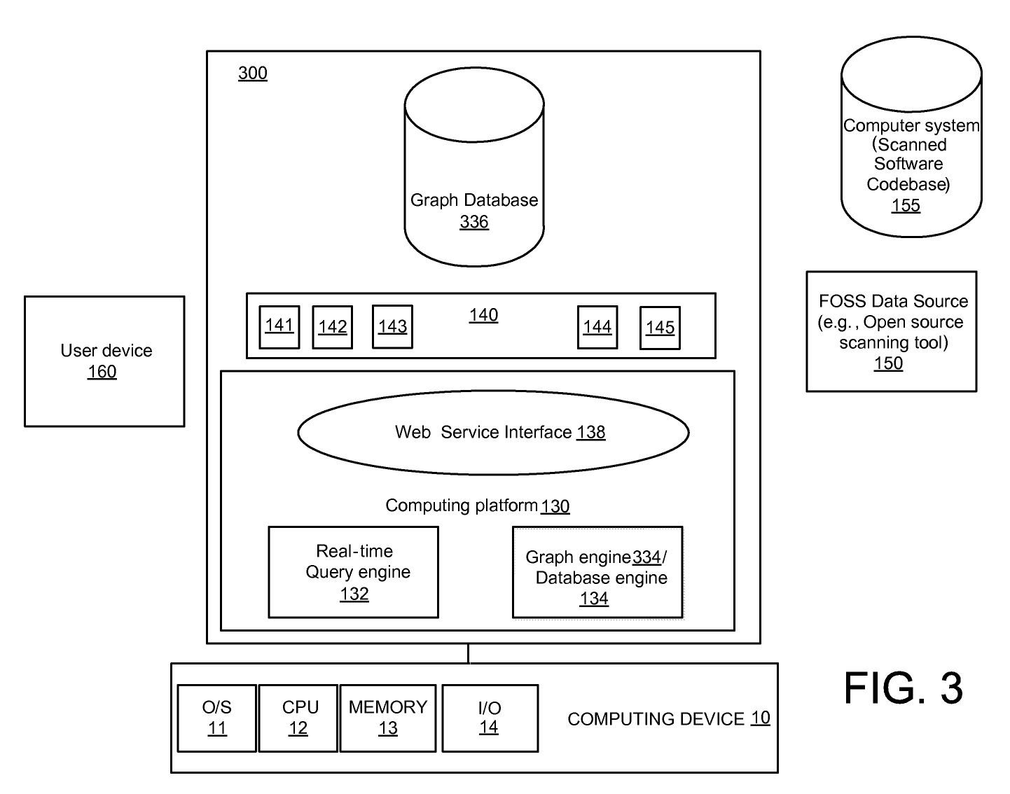

FIG. 3 shows, for example, a database management system 300 for collecting, managing and analyzing FOSS data that is stored as a graph structure in a graph database, in accordance with the principles of the present disclosure. Several of the components of system 300 may be the same or similar to the components of RDBMS 100 shown in FIG. 1 and for brevity the description of such same or similar components is not repeated herein. It will be noted that in system 300 the FOSS data may be stored in a graph database 336, which like relational database 136, may be an in-memory database. Further, in system 300, database engine 134 may further include an in-memory graph engine 334 configured to process graph data.

In an example implementation, the FOSS data/graph data may reside in in-memory graph engine 334 or in a persistence storage layer (not shown) (or in graph database 336) for backup to the extent possible. In an example implementation based on a HANA platform, query engine 132/graph engine 334 may be configured to process queries written, for example, in Weakly-structured Information Processing and Exploration (WIPE) graph language.

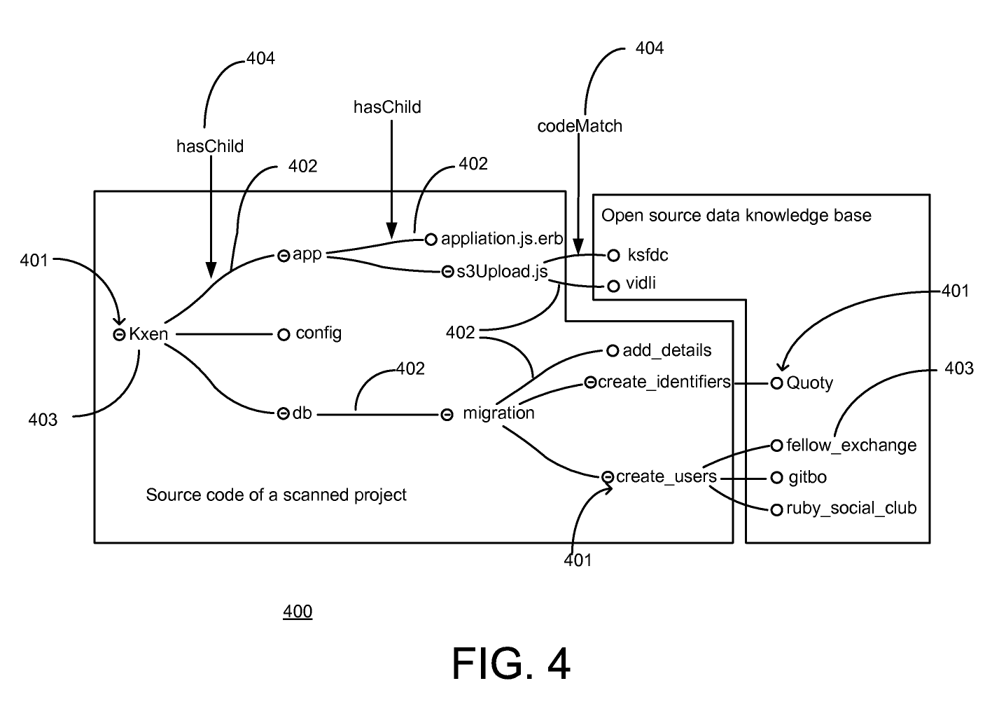

In system 300, FOSS data may be modeled as a graph structure (e.g., a hierarchical tree structure) characterized by vertices, edges and properties. FIG. 4 shows an example hierarchical tree structure model 400 of FOSS data for the source code of a scanned project. Hierarchical tree structure model 400 may include vertices or nodes 401, edges 402 and properties 404. Each vertex or node 401 of the hierarchical tree structure may, for example, represent a scanning project, a source code folder, a source file, or an open source component (in knowledge base KB). Each edge 402 of the hierarchical tree structure may represent a type of relationship between adjacent nodes. As stored in graph engine 334, each node, edge, or property representing the stored FOSS data may have respective a uniform resource identifier (URI) (e.g. identifiers 403).

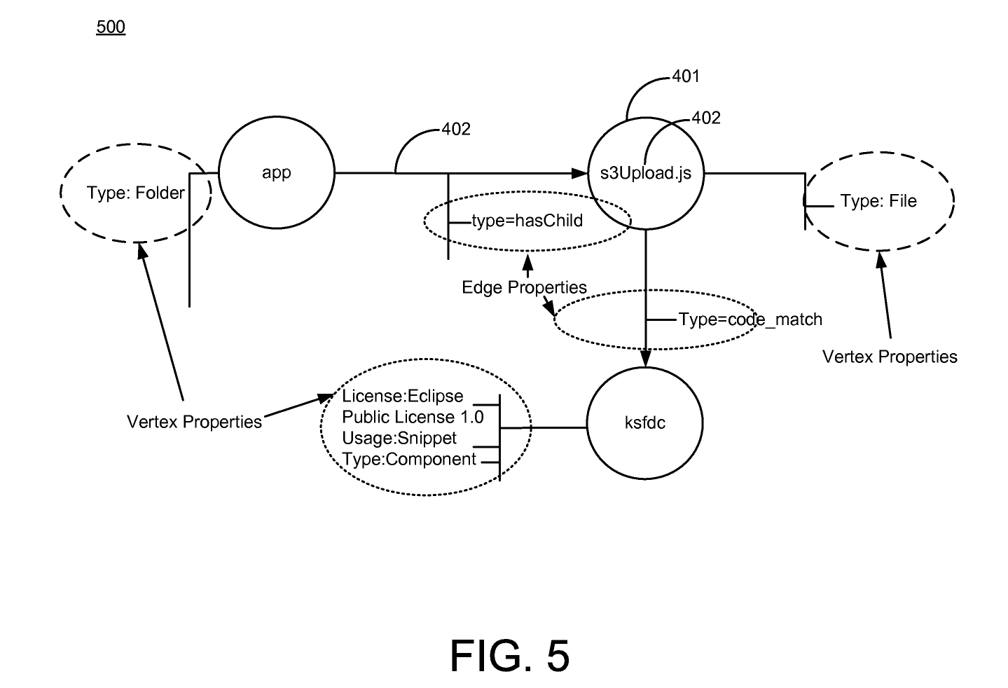

FIG. 5 illustrates example vertex or node properties and example edge properties that may characterize tree structure model 400 of FOSS data. For example, as shown in the figure, vertex properties may be characterized by attributes: Type (e.g., “File”, “Folder”, or “component”); License (e.g., “Eclipse” or “Public license 1.0”, etc.); and Usage (e.g., Snippet”, etc.), etc. Further edge properties may be characterized by the attribute: Type (e.g., “hasChild”, “code_match”, etc.).

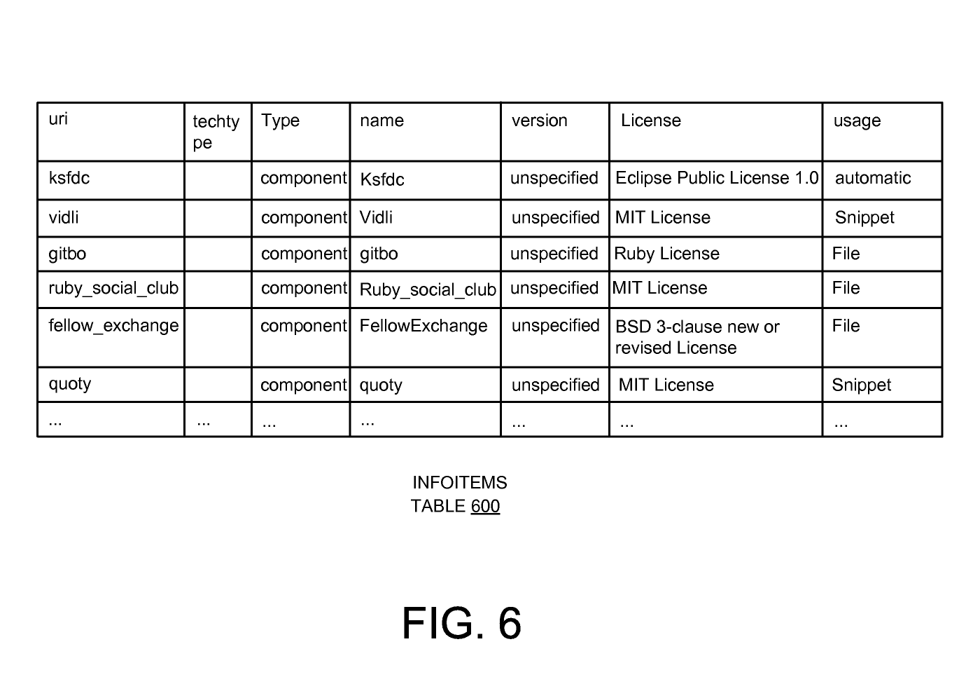

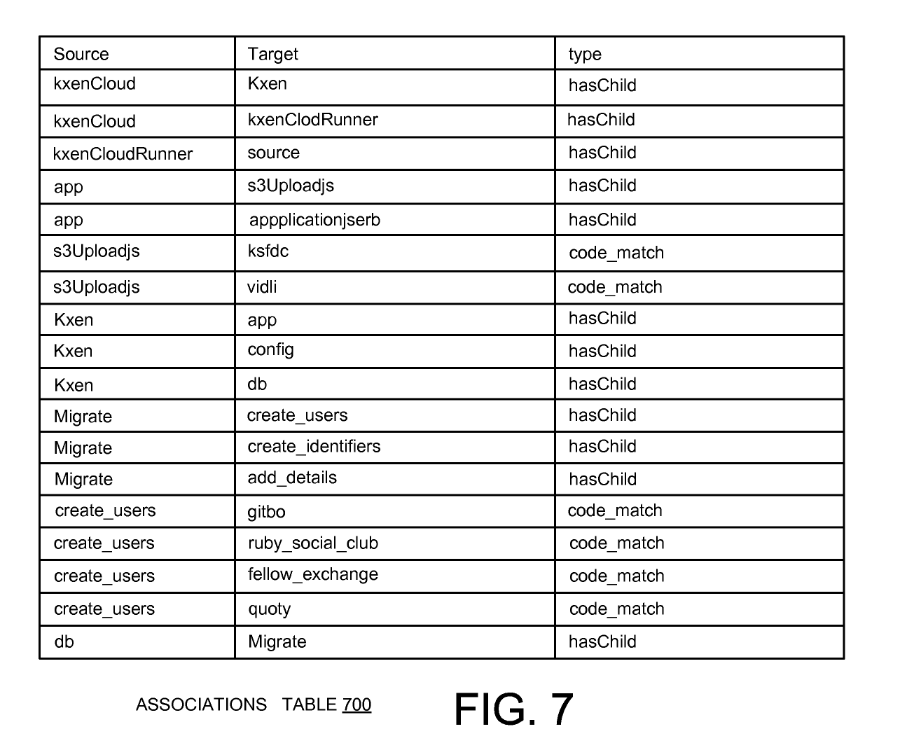

With renewed reference to FIG. 3, in system 300, the FOSS data modeled as a graph structure may be stored in graph engine 334 (or in in graph database 336) in table form. Two tables (e.g., “INFOITEMS,” FIG. 6, and “ASSOCIATIONS,” FIG. 7) may be used to represent the graph structure of the FOSS data in graph engine 334 (or in in graph database 336). As shown in FIGS. 6 and 7, a first table 600 “INFOITEMS,” may include records listing the vertex UFIs and vertex attributes (e.g., Type, Name, Version, License, and Usage) of the graph structure in column form, and a second table 700 “ASSOCIATIONS,” may include records listing edge source and target UFIs and edge attributes (e.g., type) of the graph structure in column form.

The use of graph structures to represent FOSS data in in-memory databases (e.g., graph engine 336) in system 300 and the use a graph language (e.g., WIPE) for queries may be expected to improve the performance of queries that may be used in the analysis of FOSS data for FOSS compliance.

In an experiment, query performance for FOSS compliance analysis was compared across three platforms: a traditional row-based relational database platform (e.g., a row-based database SQL platform); a column-based relational database platform (e.g., system 200 implemented on a HANA SQL platform); and a graph database platform (e.g., system 300 implemented on a HANA graph engine platform).

In the experiment, performance of six different queries of varying complexity (e.g., Query 1-Query 6) was evaluated:
Query 1: Find all distinct open source components that have matched with files of a given scanned project.
Query 2: Find all distinct files of a scanned project that have matched with a particular open source component.
Query 3: Find all distinct open source components that have matched with a particular file from a given scanned project.
Query 4: Find the number of files in a scanned project that have matched to any component with a particular license.
Query 5: Find the total number of files and the number of files that are matched to open source components.
Query 6: Find all open source components under a given folder in a scanned project that are associated with a particular license.

Queries for the first two platforms were written in SQL. Queries for the last platform were written in WIPE language. For example, for Query 1, the following SQL and WIPE syntax (codes) were used. SQL query:

select distinct oss_component_name from
code_match_discovery_table ,
oss_knowledge_base_table
where code_match_discovery_table.matchid =
oss_knowledge_base
table.componentid

WIPE query:

call wipe(‘use workspace uri:graphEngineWS;
$components=$i : $NONTERMS WHERE
$i@ais:type=“component”; RESULT
uri:myResult FROM $components
PROPERTIES ais:uri;’);
select * from “graphEngineWS”.“myResult”;

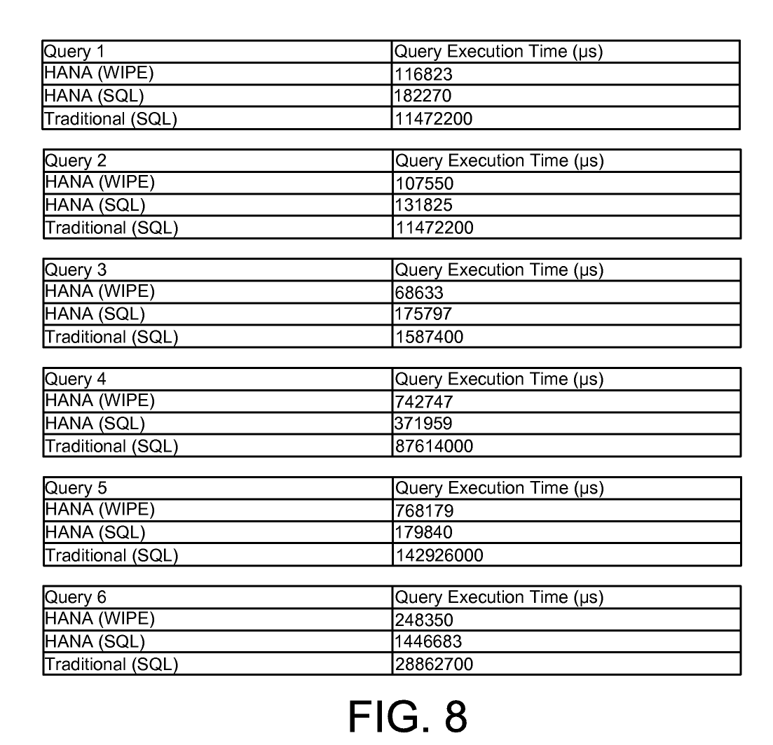

The experimental results for query execution times for the six queries (Query 1-Query 6) on the three platforms are shown in FIG. 8, TABLE 800. Inspection of the query execution time results shown in TABLE 800 reveals that compared to storing FOSS data in a traditional row-based database platform (Traditional SQL), storing FOSS data either in a column-based relational database platform (HANA SQL) or a graph database platform (HANA WIPE) yields significant improvement in data querying/processing time. The graph database platform (HANA WIPE) shows better performance for certain types of queries (e.g., queries searching for open source components under specified conditions (e.g., Query 1, Query 2, and Query 6)), while the column-based relational database platform (HANA SQL) shows better performance for other types of queries (e.g., queries searching for source code file under specified conditions (e.g., Query 3, Query 4, and Query 5)).

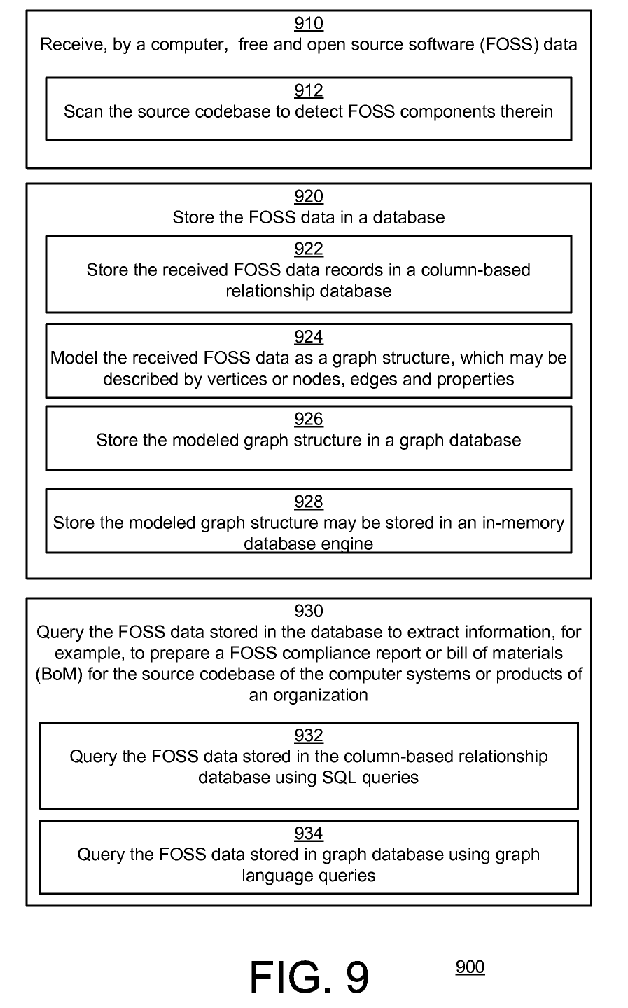

FIG. 9 shows an example method 900 for collecting, managing and analyzing information (“FOSS data”) on free and open source software (“FOSS”) components in a source codebase of computer systems or products of an organization, in accordance with the principles of the disclosure herein are described herein. The collecting, managing and analyzing information (“FOSS data”) on free and open source software (“FOSS”) components in computer systems or products of an organization may be directed to extract information which may be included in a FOSS compliance report or Bill of Materials (BoM) for the source codebase of the computer systems or products.

Each data record in the FOSS data may include identification of a detected FOSS component and include information of other attributes of the detected FOSS component. These other attributes may, for example, describe directory location, identification of the matching known open source components, potential origins of the detected FOSS component, legal notice (licenses) attached to the detected FOSS component, and other information related to various technological legal or policy obligations of using the detected FOSS component in the source or binary codebase of the computer systems or products of the organization.

Method 900 includes receiving, by a computer, FOSS data (910), storing the FOSS data in a database (920), and querying the FOSS data stored in the database to extract information, for example, to prepare a FOSS compliance report or Bill of Materials (BoM) for the source or binary codebase of the computer systems or products of the organization (930).

In method 900, receiving the FOSS data 910 may include scanning the source codebase to detect FOSS components therein (912). The scanning may involve comparing code in the source codebase with the code of known open source components, which may, for example, be listed in a knowledge base.

In an example implementation of method 900, storing the FOSS data in a database 920 may include storing the received FOSS data in a column-based relationship database (922). The column-based relationship database may, for example, be a real time in-memory database. Storing the FOSS data records attribute-by-attribute or column-by-column in a column-based in the relationship database may compress the size of the received FOSS data, which may be expected to have a high degree of redundancy. Further, querying the FOSS data stored in the database to extract information (e.g. to prepare a FOSS compliance report or bill of materials (BoM) for the source or binary codebase of the computer systems or products of the organization) 930 may include querying the FOSS data stored in the column-based relationship database using SQL queries (932).

In an alternate example implementation of method 900, storing the FOSS data in a database 920 may include modeling the received FOSS data as a graph structure, which may be described by vertices or nodes, edges and properties (924). Storing the FOSS data in database 920 may include storing the modeled graph structure in a graph database (926). The graph database may, for example, be a real time in-memory database. In an example implementation, the modeled graph structure may be stored in an in-memory database engine (928). Further, querying the FOSS data stored in the database to extract information (e.g. example, to prepare a FOSS compliance report or bill of materials (BoM) for the source or binary codebase of the computer systems or products of the organization) 930 may include querying the FOSS data stored in graph database using graph language queries (934). In an example implementation, the graph language queries may be WIPE language queries.

Method 900 may be implemented in conjunction with one or more of a database system (e.g., system 100 or system 300, FIGS. 1 and 3), an open source scanning tool or other FOSS data source (e.g., open source scanning tool 150), and a knowledge base that includes a listing of known open source software components. Various functions of method 900 may be user-controlled or interactively performed, for example, via modules 241-245 of application 140 (system 100).

The various systems and techniques described herein may be implemented in digital electronic circuitry, or in computer hardware, firmware, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for analyzing free and open source software (FOSS) data related to FOSS systems and components in source or binary codebase and/or text data written in natural languages, the method comprising:
receiving, by a computer, FOSS data, each data record in the FOSS data including identification of a FOSS component in source or binary codebase and data on one or more attributes of the FOSS component;
storing the FOSS data in a column-based relationship database; and
querying the FOSS data stored in the database to extract information to put in a FOSS compliance, quality or security report or bill of materials (BoM) for the source or binary codebase.

2. The method of claim 1, wherein receiving the FOSS data includes scanning the source or binary codebase to detect FOSS components therein.

3. The method of claim 2, wherein scanning the source or binary codebase to detect FOSS components therein includes comparing code in the source or binary codebase with the code of known open source components.

4. The method of claim 1, wherein storing the FOSS data in a column-based relationship database includes storing the FOSS data in an in-memory database.

5. The method of claim 1, wherein querying the FOSS data stored in the database to extract information to put in a FOSS compliance, quality or security report or bill of materials (BoM) for the source or binary codebase includes querying the FOSS data stored in the column-based relationship database using SQL queries.

6. A computer-implemented method for analyzing free and open source software (FOSS) data related to FOSS components in source or binary codebase, the FOSS data the method comprising:
receiving, by a computer, FOSS data, each data record in the FOSS data including identification of a FOSS component in source or binary codebase and data on one or more attributes of the FOSS component;
storing the FOSS data in a graph database; and
querying the FOSS data stored in the graph database to extract information to put in a FOSS compliance, quality or security report or bill of materials (BoM) for the source or binary codebase.

7. The method of claim 6, wherein receiving the FOSS data includes scanning the source or binary codebase to detect FOSS components therein.

8. The method of claim 7, wherein scanning the source or binary codebase to detect FOSS components therein includes comparing code in the source or binary codebase with the code of known open source components.

9. The method of claim 6, wherein storing the FOSS data in a graph database includes modeling the FOSS data as a graph structure characterized by vertices, edges and properties.

10. The method of claim 9, wherein storing the FOSS data in a graph database includes storing the modeled graph structure characterized by vertices, edges and properties in table form in the graph database.

11. The method of claim 10, wherein storing the FOSS data in a graph database includes storing the modeled graph structure in table form in an in-memory database engine.

12. The method of claim 10, wherein querying the FOSS data stored in the database to extract information includes querying the FOSS data stored in the graph database using graph language queries.

13. The method of claim 10, wherein querying the FOSS data stored in the database to extract information includes querying the FOSS data stored in graph database using Weakly-structured Information Processing and Exploration (WIPE) graph language queries.

14. A system for analyzing free and open source software (FOSS) data related to FOSS components in source or binary codebase, the system comprising a memory and a semiconductor-based processor, the memory and the processor forming one or more logic circuits configured to:
receive FOSS data, each data record in the FOSS data including identification of a FOSS component in the source or binary codebase and data on one or more attributes of the FOSS component;
store the FOSS data in a column-based database; and
query the FOSS data stored in the column-based database to extract information to put in a FOSS compliance, quality or security report or bill of materials (BoM) for the source or binary codebase.

15. The system of claim 14, wherein the logic circuits are configured to scan the source or binary codebase to detect FOSS components therein in conjunction with an open source scanning tool and a knowledge base of known open source components.

16. The system of claim 14, wherein the column-based database is a column-based relationship database, and wherein the logic circuits are configured to query the FOSS data stored in the column-based relationship in real-time using queries written in SQL.

17. The system of claim 14, wherein the FOSS data is modeled as a graph structure characterized by vertices, edges and properties, and wherein the logic circuits are configured to store the modeled graph structure characterized by vertices, edges and properties in table form in a graph database.

18. The system of claim 17, wherein the logic circuits are configured to store the modeled graph structure in table form in an in-memory database engine.

19. The system of claim 17, wherein the logic circuits are further configured to query the FOSS data stored in the graph database in real-time using queries written in graph language.

20. The system of claim 17, wherein the logic circuits are further configured to query the FOSS data stored in the graph database in real-time using queries written in Weakly-structured Information Processing and Exploration (WIPE) graph language.
